(19) United States
(12) Patent Application Publication
(10) Pub. No.: US 2006/0012163 A1
(43) Pub. Date: Jan. 19, 2006

(54) Foldout pocket guide map

(76) Inventor: Kenneth A. Shepps, New York, NY (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/892,665

(22) Filed: Jul. 16, 2004

(51) Int. Cl. B42D 15/00

(52) U.S. Cl. 283/106

(57) ABSTRACT

A fold-out pocket guide map formed from a rectilinear sheet has a number of folds and cuts along two horizontal axes and a plurality of vertical axes. Two parallel horizontal folds approximately one quarter from the top and bottom edges form two wide horizontal flaps whose edges meet close against each other to form a contiguous surface area. A plurality of equidistant vertical folds facilitates folding of the map. Cuts made on even numbered vertical folds within the horizontal flaps form smaller flaps that can be manipulated to access the surface area beneath the horizontal flaps, thereby eliminating the need to lift the horizontal flaps in their entirety. Accordion folding the sheet along the vertical axes forms dual-panel pages, each page having two movable panel flaps that may be opened independently of each other, while all unopened pages remain cleanly and conveniently collapsed in a compact state.

### FIELD OF THE INVENTION

This invention relates to a map having a pattern of fold and cut lines along which the map can be folded and opened. More particularly, the present invention relates to a pocket size laminated guide map, wherein the map or portions thereof can be opened for simultaneous viewing along with related travel and tourist information while still being at least partially folded in a compact book-like format.

### BACKGROUND OF THE INVENTION

When touring to various cities or countries around the world, travelers often use a variety of maps and books to locate various landmarks, sites and other features or items of interest, and to obtain information concerning matters such as local transportation, lodging, tourist attractions, restaurants, telephones, local customs, etc. Because all of the information a traveler may desire is frequently not contained in a single, easily carried book or map, multiple books and maps are required, each for a different topic or area. In addition, it is often difficult to match certain information that is relevant to sites of interest with the locations of those sites on a map. These problems are often exacerbated when providing travel and tourist information within the confines of the map format.

A conventional folding map consists of a relatively large sheet of paper on which the map is printed and that is folded into a convenient size, preferably along a predetermined fold pattern, for storage. This type of map is relatively inexpensive to produce, but has a distinct disadvantage in that the user must open the map fully if he or she is to comprehend the meaning of any particular part of the map. Whether in their most simplistic or multi-fold format, folding maps are not conducive to providing travel and tourist information because their presentation is restricted to either the map face, which is rarely the case because of the limited space and confusion such placement of information may cause, or the reverse side of the map. When this type of information is offered on the reverse side of the map, it is usually viewable only in the map's expanded state, requiring the user to turn the map over in its entirety or to flip and fold it over in awkward ways. Not only is the physical use of the map further hampered, but the key goal of providing the user with a sense of orientation is compromised.

Quite often this disadvantage is emphasized because the map's index is printed on the reverse side of the map. For example, when trying to locate desired information on a conventional folding map or compendium of maps and local information, there is no way to determine, before opening the map, on what part of the map the desired area is printed. Further, even if the particular area is known, it is usually necessary to unfold a large part, if not all, of the map in order to locate and view the desired area.

In addition, a conventional map is inconvenient both when used in a confined space, such as in a car, and when used outside, where wind and even gravity tend to make reading of the map difficult. Furthermore, once the map has been opened, it must be refolded. But, because it is quite often difficult to refold a map into its original folded condition, the result is that the map is often folded improperly, which leads to the weakening and eventual deterioration of the map paper and can result in a ripped or rumpled map incapable of being neatly refolded into its original compact format. Thus, whereas typical expandable folding maps offer viewing of a large area, they are difficult to use when focusing on a specific region of the map, often requiring the unfolding of the entire map and the further necessity of having to fold the map down against the fold pattern in order to view a specific area of interest.

A guide book is more convenient than a conventional map but is generally more expensive to produce. It also suffers from the disadvantage that the convenient size of the book limits the page size and consequently the amount of information that can be carried by each page. Metropolitan areas must therefore be broken down into a large number of smaller areas, and quite often a user will find that the particular part of the map that is required lies partly on one page and partly on another page in a different part of the book. This makes the guide book somewhat awkward to use and requires that the user either flip back and forth between sections of the book or relate the pages mentally.

It is also desirable that a map or guide book have an index, and that the index be in a form that is readily understood and remembered by the user so that items found in the index can then be found on the map. The foldable map has a distinct advantage in this respect because generally the index refers only to two grid references. This contrasts with a guide book, which generally requires firstly a page number, and then two grid references. Often a street will run through several pages so at a minimum the user of the book must remember three references in order to locate something found in the index on one page but may have to refer to several pages, each requiring use of three references.

Further, when a map is presented in a guide book format, it is also difficult for the user to maintain a sense of orientation because the map may be located on a page different from where the bulk of the related descriptive information is located, requiring the user to thumb-back to the map page of the guide book. Thus, in either the folding map or guide book scenario it is difficult to coordinate a point of reference with related information while maintaining a sense of orientation and perspective to the map interface. These issues often necessitate the use of multiple information sources when visiting a city; a street map for location and a broader guide for travel and tourist information.

Several folding designs used for maps or for the presentation of other information have been designed in attempt to overcome these drawbacks on the folding design. Examples of such prior art designs are found in U.S. Pat. No. 6,354,985 (Huber) for a “Fold Pattern”; U.S. Pat. No. 4,906,024 (Lein) for a “Foldable Sheet”; U.S. Pat. No. 6,045,158 (Bergstresser) for a “Foldout Information Book and Method for Making The Same”; U.S. Pat. No. 4,502,711 (Muth) for a “Sheet Folding Method and Product”; U.S. Pat. No. 4,917,405 (Muth) and U.S. Pat. No. 4,826,212 (Muth), both for a “Sheet Folding Method and Apparatus”; and U.S. Pat. No. 5,156,898 (McDonald) for a “Folded Sheet”.

However, each of these designs contains excessive use of cuts and creases, such as those designs that use a series of cuts and creases to expand from a limited common axis, designs that expand out solely from a series of fold creases along rectilinear lines, or designs that employ a series of interleave folds along angles to collapse into a compact state. With the first two types, as with traditional folding designs, the foldouts are still unwieldy and difficult, if not problematic, to manipulate for viewing in their entirety or for viewing a specific area. Furthermore, these designs utilize crease lines that are prone to fold in the opposite direction than intended, resulting in a bulkier map in the collapsed state. With the third type of map design, the shape is often difficult to maintain if even one of the folds is not exactly in place prior to collapse, thereby resulting in folds that form against the creases and fall outside of the compact format. All of the aforementioned designs also often tear along crease lines with minimal use because of the thinner paper gauge required to support the efficiency of the interleaving folding method that they employ. Furthermore, and importantly, none of the aforementioned designs offer any alternative to the placement of related additional information and, therefore, continue with the limited and problematic use of placing such information on the front or back of the map sheet.

It is thus an object of the invention to provide a folding guide map that can expand and contract readily and conveniently to offer both full viewing of a large area and viewing of a particular area, without requiring a complex folding design of multiple creases and cuts in a folding pattern that is difficult to manipulate and fold-down and that results in eventual tearing along the crease lines.

It is another object of the present invention to create a folding map design that will display travel and tourist information within the context and proximity of the map section being viewed. These problems can be solved with a folding map design employing a pattern of limited crease folds and cuts that enable segments of the map to be lifted or lowered without expanding the entire map and, in so doing, provides space for incorporating information that is viewable and accessible in a compact state without requiring cumbersome unfolding and refolding, flipping over, compromising the map face with verbiage or, necessitating reference to a secondary information source.

### SUMMARY OF THE INVENTION

In accordance with these and other objects of the invention, a foldout pocket guide map is provided having a plurality of accordion-like alternating folds that define a plurality of panels therebetween, each of the panels comprising an upward unfolding flap and a downward unfolding flap for display of additional information. The folding map design is preferably formed from a rectilinear sheet with two horizontal parallel folds, one preferably approximately a quarter from one long side (the bottom) of the sheet and the other preferably approximately a quarter from the other long side (the top) of the sheet. The top and bottom edges of the sheet are folded downward and upward, respectively, to create two elongated horizontal flaps that meet approximately along the elongated center horizontal axis plane line of the sheet. Additional folds that are then made on equidistant vertical axis lines result in crease folds that, when the sheet is folded in an alternating, e.g., zig-zag or accordion, fashion, serve to create pages of panels that can be folded into an accordion-like compact state.

On every second equidistant vertical axis, starting from the second on the left hand side, a cut is made inward along the vertical axis portion within the horizontal fold flap both from the top and from the bottom of the rectilinear sheet, resulting in the creation of smaller top and bottom flaps. Each page is thus comprised of two adjoining panels and a top and bottom dual-panel flap that folds together with the two panels. Map information can be printed on the two adjacent panels, and additional information relating to the map information can be printed on the front and back sides of the dual panel flap that covers the two panels. The smaller flaps can each be lifted up (i.e., folded upward for top flaps or downward for bottom flaps) independently of the others, whether the map is in an expanded state or is open to the first page of panels or to any page of panels thereafter.

Thus, while the typical folding map design limits the amount of the information that is available to the front and back surfaces of the map, the inventive map design utilizes an additional surface area for another layer of information, whereby the result is that the total amount of viewable frontal surface space available is essentially tripled. Not only is the surface area space substantially increased, but the ease of use in accessing relevant information is enhanced. With the accordion fold, the user can view the map in a book-like format with only one page of panel flaps open at a time, can view the map in a partially expanded format for viewing of a larger portion of the map, or can view the map in its completely expanded format for viewing of the map in its entirety.

The inventive map design overcomes the excessive use of cuts and creases employed in other folding designs, such as those discussed previously. With the unique folding and cut pattern of the present invention, the use of cuts and creases in the map surface is minimized, thus eliminating the awkward foldout and collapse required when using other maps. The folding pattern of the inventive map design lends itself to a durable format that maintains the map's shape and usefulness. The additional layer of surface area furthermore enables the placement of related information within proximity to and accessible from the map frontage, without confusing the map face, necessitating the user to turn the map over or requiring the user to reference another information source. Thus, in the inventive map it is possible to access travel and tourist information within the context and parameters of the map area depicted.

### BRIEF DESCRIPTION OF THE DRAWINGS

The above and other objects and advantages of the invention will be apparent upon consideration of the following detailed description, taken in conjunction with the accompanying drawings, in which the reference characters refer to like parts throughout and in which:

FIG. 1 shows the rectilinear sheet with two parallel dotted lines marking two major fold creases along the horizontal axes;

FIG. 2 shows the rectilinear sheet with the top and bottom elongated horizontal flaps created by folding along the aforesaid horizontal axes;

FIG. 3 shows the rectilinear sheet with the elongated horizontal flaps folded flat;

FIG. 4 shows the rectilinear sheet with the addition of vertical dotted lines marking crease folds along five equidistant vertical axes;

FIG. 5 shows the rectilinear sheet having cuts (solid lines) formed partially downward from the top edge of the sheet and partially upward from the bottom edge of the sheet on the second and fourth vertical axes;

FIG. 6 shows the rectilinear sheet as in FIG. 5 having panel flaps created by the vertical axis cuts partially folded inward;

FIG. 7 shows the rectilinear sheet with the panel flaps created by the vertical axis cuts completely folded inward and the sheet folded in an accordion folding pattern created by folding the sheet along the vertical axes such that the vertical panels are folded into one another; and

FIG. 8 shows the rectilinear sheet in its completely folded guidebook form, but open to the first panel page with the upper dual panel flap lifted.

### DETAILED DESCRIPTION OF THE INVENTION

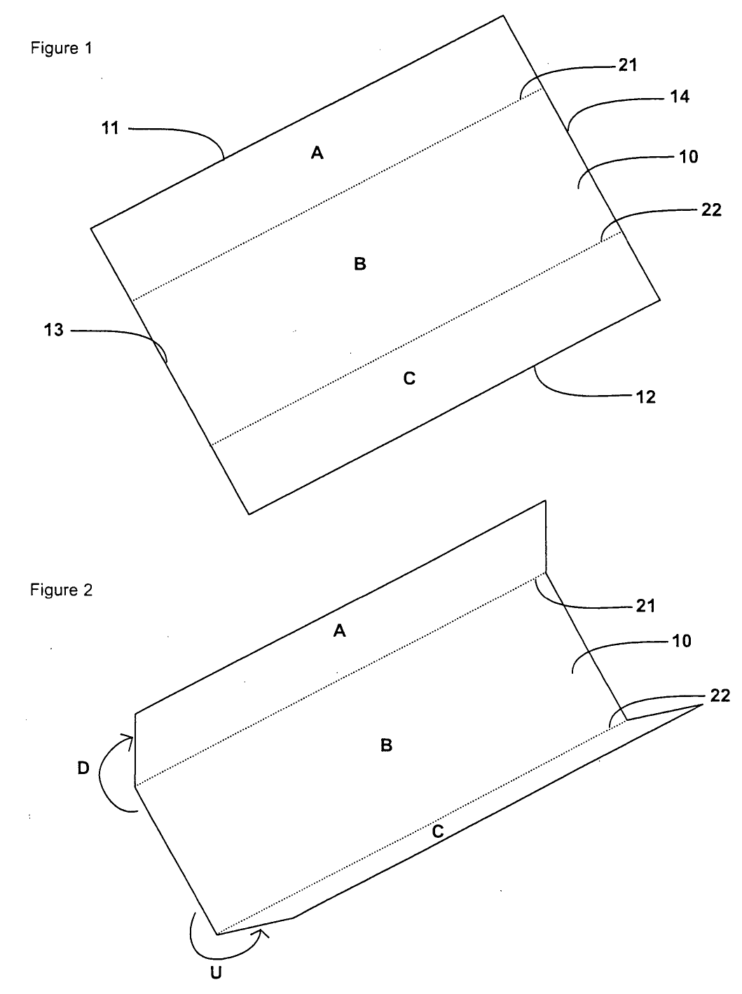

The following is a brief description of the basic embodiments of the present invention. As illustrated in FIG. 1, sheet 10 is generally rectangular, with top and bottom edges 11,12 and left and right side edges 13,14. In a preferred embodiment, top and bottom edges 11,12 are longer than left and right side edges 13,14, such that sheet 10 is longer in its horizontal direction than it is in its vertical direction. For example, in one preferred embodiment, sheet 10 is approximately 17″ in height and 24″ in width. Of course, sheet 10 can have other height and width distance combinations without departing from the principles and objects of the invention. In order to preclude damage to the corners of sheet 10, sheet 10 may be provided with slightly rounded edges at its corners.

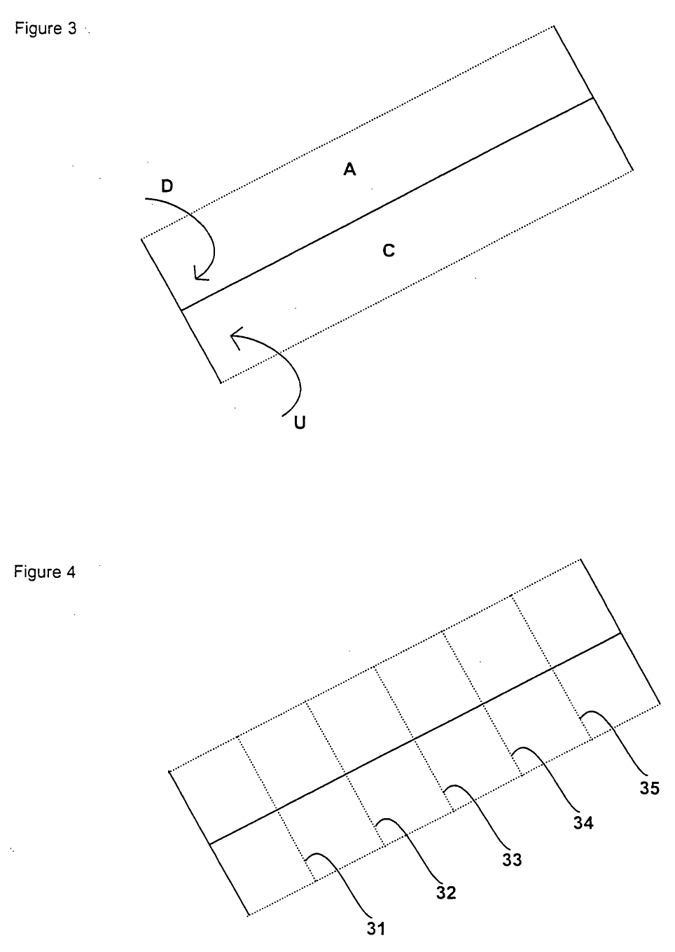

As illustrated in FIG. 1, sheet 10 has two major fold or score lines 21,22, shown as dotted lines, that extend completely across sheet 10 from left side edge 13 to right side edge 14, running preferably parallel to each other and to top and bottom edges 11,12, respectively. Fold lines 21,22 divide sheet 10 into three separate portions—top portion A, body portion B and bottom portion C. As illustrated in FIG. 2, when sheet 10 is folded along fold lines 21,22, two horizontal flaps A and C are created. Horizontal flap A is folded along fold line 21 down in the direction of arrow D towards body portion B and horizontal flap C is folded along fold line 22 up in the direction of arrow U towards body portion B. FIG. 3 illustrates flaps A and C folded completely along fold lines 21,22 in the directions of arrows D and U, respectively, such that each rests flat against the front surface of body portion B of sheet 10.

Fold line 21 is preferably situated approximately one quarter or less of the height of sheet 10 from top edge 11 of sheet 10, and fold line 22 is preferably situated approximately one quarter or less of the height of sheet 10 from bottom edge 12 of sheet 10. For example, if sheet 10 is approximately 17″ in height, each of fold lines 21,22 is preferably approximately 4.25″ or less from its respective edge 11,12 of sheet 10. Thus, in this embodiment, when horizontal flap A is folded along fold line 21 down in the direction of arrow D towards body portion B and horizontal flap C is folded along fold line 22 up in the direction of arrow U towards body portion B such that each rests flat against the front surface of body portion B of sheet 10, top edge 11 of sheet 10 (which is the remote edge of flap A) and bottom edge 12 of sheet 10 (which is the remote edge of flap C) abut against or rest very close to each other, as shown in FIG. 3, at approximately the horizontal center line of body portion B of sheet 10. When flaps A and C are folded over in this manner with their edges 11,12 abutting against or resting close to each other, a contiguous surface area is created, as shown in FIG. 3, comprised of the back surfaces of flaps A and C. This surface area may be used for printing of a map or other information.

In the embodiment illustrated in FIG. 3, wherein the height of each of flaps A and C measures exactly one quarter of the height of sheet 10, only the back surfaces of flaps A and C are visible once flaps A and C are folded over onto body portion B. Thus, if sheet 10 is approximately 17″ in height and 24″ in width, each of flaps A and C is preferably approximately 4.25″, and the surface area of the visible information face is comprised of the surface area of the back sides of flaps A and C (in their folded state), an area measuring a height of 8.5″ and a width of 24″. In alternative embodiments, where the height of each of flaps A and C measures less than one quarter of the height of sheet 10, once flaps A and C are folded over onto body portion B, part of the front face of body portion B is visible between the back surfaces of flaps A and C.

The front and back sides of flaps A and C can have information printed thereon that is related to body portion B. For example, information, such as a geographic map, can be printed on the front side of body portion B, and additional information, such as information regarding restaurant, lodging or sites of interest, relating to the map information can be printed on both the front and back of the flaps A and C. Alternatively, information, such as a geographic map, can be printed on the back side of flaps A and C (in their folded state), and additional information, such as information regarding restaurant, lodging or sites of interest, relating to the map information can be printed on both the front of flaps A and C (in their unfolded state) and the front of body portion B. In either situation, it is preferred that the information printed on specific regions of flaps A and C be directly related to the information on body portion B that is directly below or above those specific regions. For example, the information regarding restaurant, lodging or sites of interest relating to a specific geographic region of the map printed on body portion B should preferably be situated on areas of flaps A and C that are proximal to the areas on the map of body portion B where the specific geographic region appears.

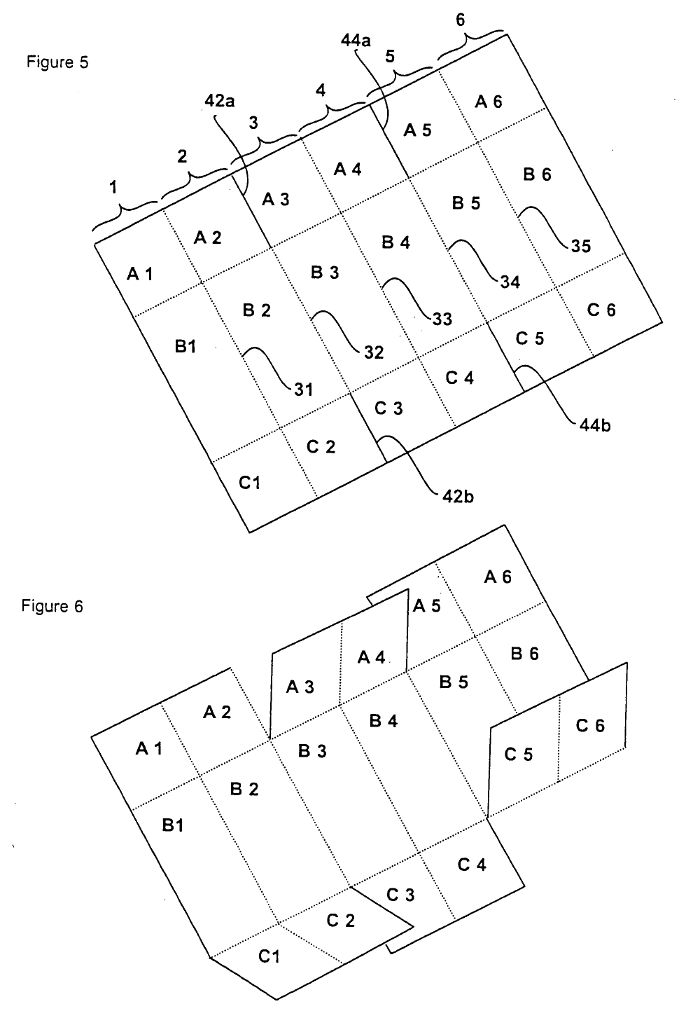

Sheet 10 also includes a plurality of vertical transverse fold lines 31-35 running generally parallel to each other and to side edges 13,14 but perpendicular to top and bottom edges 11,12 of sheet 10. In the illustrated preferred embodiment, as shown in FIG. 5, five vertical transverse fold lines 31-35, shown as dotted lines, extend completely across sheet 10 from top edge 11 to bottom edge 12, dividing sheet 10 into six vertically-rectangular panels 1-6. Fold lines 31-35 run transverse to each of top portion A, body portion B and bottom portion C of sheet 10, dividing each of those portions into six sections, such that top portion A is divided into sections A1-A6, body portion B is divided into sections B1-B6, and bottom portion is divided into sections C1-C6.

Preferably, vertical transverse fold lines 31-35 are formed equidistant to each other along the width of sheet 10 such that the panels 1-6 have equal width. For example, in one preferred embodiment, as shown in FIG. 5, if sheet 10 is approximately 24″ in width, each of the six equidistant panels is approximately 4″ in width and approximately 17″ in height. FIG. 4 shows flaps A and C folded inward and covering body portion B, such that, if sheet 10 is approximately 17″ in height and 24″ in width, the six equidistant panels are each about 4″ in width and about 8.25″ in height.

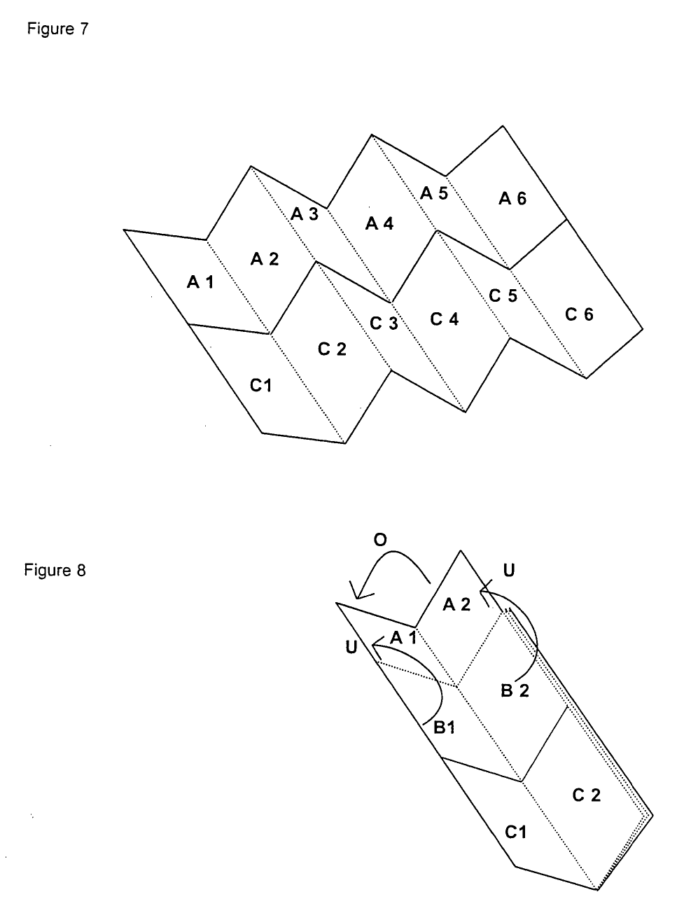

Sheet 10 is then folded along fold lines 31-35 in an accordion or zig-zag fashion, such that successive sets of panels, i.e., panels 1 and 2, panels 3 and 4, and panels 5 and 6, face each other. As seen in FIG. 7, flaps A and C have been folded inward and cover body portion B, and then sheet 10 is accordion folded along fold lines 31-35. Thus, as seen in the partially accordion-folded embodiment shown in FIG. 7, once sheet 10, with flap A folded downward to body portion B and flap C folded upward to body portion B, is completely accordion folded, the backs of panels A1 and A2 and the backs of panels C1 and C2 face each other, the backs of panels A3 and A4 and the backs of panels C3 and C4 face each other, and the backs of panels A5 and A6 and the backs of panels C5 and C6 face each other. In this folded configuration, sheet 10 resembles a booklet, with successive pages formed from successive pairs of back to back panels.

It should be noted that, whereas five equidistant vertical transverse fold lines 31-35 are illustrated here with six resulting equi-width panels, the number of fold lines can be selected at any number. Thus, in alternative preferred embodiments, depending upon how many panels are needed or desired for any particular application, a larger or smaller number of vertical transverse fold lines is made across sheet 10 from top edge 11 to bottom edge 12, so as to divide sheet 10 into more or fewer vertically-rectangular panels. For example, if eight panels were needed, sheet 10 would have seven fold lines running transverse to top portion A, body portion B and bottom portion C of sheet 10, dividing each of those portions into eight panels.

Where it is desired that sheet 10 be folded in an accordion fashion to result in a book-like format, the number of fold lines can be selected at any number, provided the number allows the accordion-type vertical fold to occur, and it is preferred that there be an even number of panels so that adjacent sets of two successive panels have their front sides facing each other. In such an embodiment, there should be an odd number of transverse fold lines (e.g., exactly one fewer transverse fold lines than panels desired) in order to separate sheet 10 into the desired even number of panels. For example, in the embodiment shown in FIGS. 1-8, five vertical transverse fold lines 31-35 are shown that divide sheet 10 into six equidistant panels, three successive pairs of which are faced towards each other after sheet 10 has been accordion folded. Should it be desired to have, for example, four successive pairs of panels that are faced towards each other in an accordion folded sheet, eight panels must be subdivided from the sheet, meaning that seven vertical transverse fold lines would be required. More or fewer successive pairs of panels can be arranged by making sheet 10 wider or narrower and by having more or fewer fold vertical transverse fold lines.

Referring again to FIG. 5, also illustrated are a series of transverse slits or cuts made partially along selected fold lines 31-35. These transverse cuts are made on the upper portion and bottom portion of the selected vertical transverse fold lines. In FIG. 5, the slits or cuts are shown in solid line on dotted lines along portions of primary folds 32 and 34.

In a preferred embodiment, as illustrated in FIG. 5, the transverse slits or cuts are provided along every other vertical transverse fold line 31-35, beginning with the second vertical transverse fold line 32, i.e., at fold lines 32 and 34. As a result of these cuts, dual panel flaps are formed from top flap A and bottom flap C. Thus, in one preferred embodiment wherein sheet 10 is approximately 17″ in height and 24″ in width, such a top cut and a bottom cut are made along each of the second and fourth vertical transverse fold lines, such that three dual panel flaps are formed from top flap A and three dual panel flaps are formed from bottom flap C, each with approximately an 8″ width and approximately a 4.25″ height.

The number of transverse cuts depends upon the number of dual panel flaps that are to be formed. While it is preferred that the transverse cuts be made along the second vertical transverse fold line and on every subsequent second vertical transverse fold line, a different number of transverse cuts may be made. For example, transverse cuts may be made at more than the number of vertical transverse fold lines in the preferred embodiment. In one alternative embodiment, transverse cuts may be made at every vertical transverse fold line, such that single panel flaps are formed from top flap A and bottom flap C.

It is preferred that the transverse cuts be made completely across the height of flaps A and B. Transverse cuts 42a and 44a are made from top edge 11 of sheet 10 completely across top flap A to fold line 21, and transverse cuts 42b and 44b are made from bottom edge 12 of sheet 10 completely across bottom flap C to fold line 22. Thus, if sheet 10 is approximately 17″ in height and 24″ in width, each of transverse cuts 42a, 44a, 42b and 44b is preferably approximately 4.25″ or less, i.e., the height of flaps A and C.

Cuts 42a and 44a in top flap A form dual panels flaps A1-A2, A3-A4 and A5-A6, and cuts 42b and 44b in bottom flap C form dual panel flaps C1-C2, C3-C4 and C5-C6, each of which dual panel flaps can be folded inward or outward independently of the others. As illustrated in FIG. 6, each of these dual panel flaps can be lifted independently of the others. In the alternative embodiment wherein transverse cuts are made across top flap A and bottom flap C at every vertical transverse fold line thereof so as to form single panel flaps, each of these single panel flaps can be folded inward or outward independently of the others. In order to preclude damage to the corners of any single or dual panel flaps A or C, sheet 10 may be provided with slightly rounded corner edges at the corner of each transverse cut, e.g., 42a, 42b, 44a and 44b.

As illustrated in particular in FIG. 7, sheet 10 having fold lines 21,22 and 31-35 and having cuts 42a, 44a, 42b and 44b is prepared for use as a foldout guide map. First, top flaps A and bottom flaps C are folded inward towards body portion B along fold lines 21,22. Then, sheet 10 is accordion folded along fold lines 31-35. In this configuration, each body portion panel faces one horizontally adjacent panel and backs up against another horizontally adjacent panel. Thus, panels B1 and B2, panels B3 and B4 and panels B5 and B6 face each other, while panels B2 and B3 and panels B4 and B5 back up against each other. Similarly, in this configuration, the backs of adjacent panels of dual panel flaps in the folded state face each other. Thus, the backs of panels A1 and A2 and the backs of panels C1 and C2 face each other (in their folded state), the backs of panels A3 and A4 and the backs of panels C3 and C4 face each other (in their folded state), and the backs of panels A5 and A6 and the backs of panels C5 and C6 face each other (in their folded state). As such, sheet 10 is sized down to a guidebook-like compact map format and results in a folded format a size equal to that of one central portion B panel.

As shown in FIG. 8, once the sheet 10 is folded into this compact format, the user can use the folded sheet as a folded guide map by opening and unfolding sections easily and neatly. As discussed above, information, such as a geographic map, can be printed on the front sides of all B panels, and additional information relating to the map information, such as information regarding restaurant, lodging or sites of interest, can be printed on both the front and back of the adjacent dual panel A and C flaps. Alternatively, a geographic map can be printed on the back sides of adjacent dual panel A and C flaps (in their folded state) and related information can be printed on the front sides of all B panels and the front sides of adjacent dual panel A and C flaps (in their unfolded state). The user can open the cover of the map (actually the back side of panel B1) in the direction of arrow O to reveal the first page of the map, which is two adjacent and facing panels (the front sides of panels B1 and B2) with two attached flaps, one upward (dual panel flap A1-A2) and one downward (dual panel flap C1-C2), that, in their folded state, together substantially cover the front sides of panels B1 and B2.

Either one or both of these dual panel flaps A1-A2 and C1-C2 can be lifted to reveal additional information thereunder, without the user having to open the guide map in its entirety or to flip and contort it in any manner. FIG. 8 shows the first page of the pocket guide map open, with the top dual panel flap A1-A2 turned upward, i.e., unfolded, in the direction of arrows U to reveal whatever information lies under the top dual panel flap A1-A2, and with the bottom dual flap C1-C2 in its compact, i.e., folded, state, not turned downward. Lifting a dual panel flap reveals a surface area underneath that comprises the underside of the dual flaps (e.g., A1-A2) and the surface area of center portion dual panel (e.g., B1-B2) that the dual panel flap covers. This total surface area underneath the dual panel flap is approximately double the surface area of the back face of each dual panel flap (in its folded state) of the rectilinear map sheet in its collapsed, i.e., folded, state.

Once the dual panel flaps A1-A2 and C1-C2 are replaced in position over panels B1-B2 (or even if the dual panel flaps are not re-folded downward over panels B1-B2), the user can turn the map to the next page to view the next two covering dual panel flaps (e.g., A3-A4 and C3-C4 in their folded state), the related information on the underside (i.e., the front face, in the unfolded state) of the dual panel flaps and the two body panels (e.g., B3-B4) covered by those dual panel flaps.

The material for sheet 10 can be freely selected within any number of materials available in the art, but should preferably be a flexible, relatively thin material. More preferably, sheet 10 can be strengthened by a reinforcing coating, such as a laminate or similar material that is widely available in the art. Further preferably, the reinforcing coating may be applied, as is known in the art of lamination or reinforced coatings, such that folding of the various fold lines is strongly encouraged only in specific directions. Thus, for example, for countries in which text and books are read from left to right, it is preferred that sheet 10 is accordion folded so that the folded panel flaps A1-A2 and C1-C2 covering the corresponding body panels B1 and B2 face each other, the folded panel flaps A3-A4 and C3-C4 covering the corresponding body panels B3 and B4 face each other, and the folded panel flaps A5-A6 and C5-C6 covering the corresponding body panels B5 and B6 face each other. Furthermore, the fold lines can be scored such that folding in this manner is encouraged, e.g., by having less coating on the front face of sheet 10 along fold lines 31, 33 and 35 and on the back face of sheet 10 along fold lines 32 and 34. Similarly, for countries in which text and books are read from right to left, the preferred direction of accordion folding sheet 10 can be reversed.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Similarly, changes in direction of folds of any portions of sheet 10 or in the direction of opening the resulting map guidebook are also included.

Thus, a foldout pocket guide map has been provided. One skilled in the art will appreciate that the present invention can be practiced by other than the described embodiments, which are presented for purposes of illustration and not limitation. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A foldable sheet comprising:
a sheet having front and back sides, top and bottom edges, and left and right sides,
two substantially parallel lengthwise folds across the width of said sheet forming an elongated upper flap, an elongated body portion and an elongated lower flap,
a plurality of substantially parallel transverse folds across the height of said sheet and substantially perpendicular to said lengthwise folds, forming from said elongated body portion a series of panels,
a plurality of cuts formed across said upper and lower flaps along selected ones of said transverse folds, such that said upper and lower flaps are subdivided into a plurality of sub-flaps, each of which sub-flaps corresponds to at least one body portion panel, and
said panels being arranged to be folded one on top of another in an accordion fashion to form a book-like assembly, wherein each successive set of two adjacent panels has the front sides of said body portion panels facing each other and comprises at least one upper sub-flap formed by said cuts capable of being unfolded upwardly away from its corresponding at least one body portion panel and at least one lower sub-flap formed by said cuts capable of being unfolded downwardly away from its corresponding at least one body portion panel.

2. The foldable sheet according to claim 1 wherein the back side of a first panel forms a front cover for said book-like assembly and the back side of a last panel forms a rear cover for said book-like assembly.

3. The foldable sheet according to claim 1 wherein each of said body portion panels is of substantially equal width.

4. The foldable sheet according to claim 1 wherein each sub-flap corresponds to two body portion panels, such that each set of two adjacent panels comprises one upper sub-flap capable of being unfolded upwardly away said two adjacent panels and one lower sub-flap capable of being unfolded downwardly away from said two adjacent panels.

5. The foldable sheet according to claim 1 wherein each sub-flap corresponds to one body portion panel, such that each set of two adjacent panels comprises two upper sub-flaps capable of being unfolded upwardly away said two adjacent panels and two lower sub-flaps capable of being unfolded downwardly away from said two adjacent panels.

6. The foldable sheet according to claim 1 further comprising printed indicia on the front face and the back face of said sheet, such that, when said sheet is accordion folded, the printed indicia on the front and back of each sub-flap is related to the printed indicia on the front side of at least one body portion panel corresponding to that sub-flap.

7. The foldable sheet according to claim 6 wherein the printed indicia on said body portion of said sheet is a geographic map, and the printed indicia on said front face and the back face of said sub-flaps is information related to said geographic map.

8. The foldable sheet according to claim 6 wherein the printed indicia on the back face of said sub-flaps is a geographic map, and the printed indicia on said body portion of said sheet and on said front face of said sub-flaps is information related to said geographic map.

9. The foldable sheet according to claim 1 wherein each of said two lengthwise folds is made approximately one quarter or less across the height of said sheet, such that when said elongated upper flap and said elongated lower flap are folded over said elongated body portion the top and bottom edges of said sheet do not overlap.

10. A foldable map comprising:
a sheet having front and back sides, top and bottom edges, and left and right sides,
two substantially parallel lengthwise folds across the width of said sheet forming an elongated upper flap, an elongated body portion and an elongated lower flap, said elongated body portion having first information or indicia printed thereon and said elongated upper and lower flaps having second information or indicia printed on the front side thereof and third information or indicia printed on the back side thereof,
a plurality of substantially parallel transverse folds across the height of said sheet and substantially perpendicular to said lengthwise folds, forming from said elongated body portion a series of panels,
a plurality of cuts formed across said upper and lower flaps along selected ones of said transverse folds, such that said upper and lower flaps are subdivided into a plurality of sub-flaps, each of which sub-flaps corresponds to at least one body portion panel,
said panels being arranged to be folded one on top of another in an accordion fashion to form a book-like assembly, wherein each successive set of two adjacent panels has the front sides of said body portion panels facing each other and comprises at least one upper sub-flap formed by said cuts capable of being unfolded upwardly away from its corresponding at least one body portion panel and at least one lower sub-flap formed by said cuts capable of being unfolded downwardly away from its corresponding at least one body portion panel, and
wherein the second and third information or indicia printed on the front and back of each sub-flap is closely related to the first information or indicia printed on the front side of at least one body portion panel corresponding to that sub-flap.

11. The foldable sheet according to claim 10 wherein each sub-flap corresponds to two adjacent body portion panels, such that each set of two adjacent body portion panels comprises one upper sub-flap capable of being unfolded upwardly away from said two adjacent body portion panels and one lower sub-flap capable of being unfolded downwardly away from said two adjacent body portion panels.

12. The foldable sheet according to claim 10 wherein each sub-flap corresponds to one body portion panel, such that each set of two adjacent panels comprises two upper sub-flaps capable of being independently unfolded upwardly away from said two adjacent body portion panels and two lower sub-flaps capable of being independently unfolded downwardly away from said two adjacent body portion panels.

13. The foldable sheet according to claim 10 wherein the first printed information or indicia printed on said body portion is a geographic map, and the second and third printed information or indicia printed on the front face and the back face of said sub-flaps is information related to said geographic map.

14. The foldable sheet according to claim 10 wherein the third printed information or indicia printed on the back face of said sub-flaps is a geographic map, and the first and second printed information or indicia printed on said body portion and on the front face of said sub-flaps is information related to said geographic map.

15. The foldable map according to claim 10 wherein each of said two lengthwise folds is made approximately one quarter or less across the height of said sheet, such that, when said elongated upper flap and said elongated lower flap are folded over said elongated body portion, the top and bottom edges of said sheet do not overlap.

16. A method for preparing a book-like assembly from a rectilinear sheet, comprising:
forming two substantially parallel lengthwise folds across said sheet to divide an elongated upper flap along an upper edge of said sheet, an elongated lower flap along a lower edge of said sheet and an elongated body portion between said upper and lower flaps,
forming a plurality of substantially parallel transverse folds across the height of said sheet and substantially perpendicular to said lengthwise folds, thereby dividing said elongated body portion into a series of panels,
making a plurality of cuts across said upper and lower flaps along selected ones of said transverse folds, thereby subdividing said upper and lower flaps into a plurality of sub-flaps, each of which sub-flaps corresponds to at least one body portion panel, and
folding said panels one on top of another in an accordion fashion, wherein each successive set of two adjacent panels has the front sides of said body portion panels facing each other and comprises at least one upper sub-flap formed by said cuts capable of being unfolded upwardly away from its corresponding at least one body portion panel and at least one lower sub-flap formed by said cuts capable of being unfolded downwardly away from its corresponding at least one body portion panel.

17. The method according to claim 16 wherein said step of forming two substantially parallel lengthwise folds comprises folding said sheet approximately one quarter or less across the height of said sheet from the top edge of said sheet and folding said sheet approximately one quarter or less across the height of said sheet from the bottom edge of said sheet, such that when said elongated upper flap and said elongated lower flap are folded over said elongated body portion the top and bottom edges of said sheet do not overlap.

18. The method according to claim 16 wherein said step of forming a plurality of substantially parallel transverse folds comprises dividing said elongated body portion into a series of panels of substantially equal width.

19. The method according to claim 16 wherein said step of making a plurality of cuts across said upper and lower flaps comprises subdividing said upper and lower flaps into a plurality of sub-flaps such that each sub-flap corresponds to two body portion panels, whereby each set of two adjacent panels comprises one upper sub-flap capable of being unfolded upwardly away from said two adjacent panels and one lower sub-flap capable of being unfolded downwardly away from said two adjacent panels.

20. The method according to claim 16 wherein said step of making a plurality of cuts across said upper and lower flaps comprises subdividing said upper and lower flaps into a plurality of sub-flaps such that each sub-flap corresponds to one body portion panel, whereby each set of two adjacent panels comprises two upper sub-flaps capable of being unfolded upwardly away from said two adjacent panels and two lower sub-flaps capable of being unfolded downwardly away from said two adjacent panels.

21. The method according to claim 16 further comprising printing indicia on the front face and the back face of said sheet, such that, when said sheet is folded in an accordion fashion, the printed indicia on the front and back of each sub-flap relates to the printed indicia on the front side of at least one body portion panel corresponding to that sub-flap.

22. The method according to claim 21 wherein the printed indicia on said body portion of said sheet is a geographic map, and the printed indicia on said the front face and the back face of said sub-flaps is information related to said geographic map

23. The method according to claim 21 wherein the printed indicia on the back face of said sub-flaps of said sheet is a geographic map, and the printed indicia on said body portion and on the front face of said sub-flaps is information related to said geographic map.
